(19) United States
(12) Patent Application Publication
(10) Pub. No.: US 2024/0230162 A1
(43) Pub. Date: Jul. 11, 2024

(54) SOLAR POWERED WATER HEATER

(71) Applicant: Great American Merchandise & Events, LLC, Scottsdale, AZ (US)

(72) Inventors: Luis Vendrell, Gilbert, AZ (US); Stephen Taylor, Scottsdale, AZ (US)

(73) Assignee: Great American Merchandise & Events, LLC, Scottsdale, AZ (US)

(21) Appl. No.: 18/408,136

(22) Filed: Jan. 9, 2024

Related U.S. Application Data
(60) Provisional application No. 63/438,318, filed on Jan. 11, 2023.

(51) Int. Cl. F24S 10/17

(52) U.S. Cl. CPC F24S 10/17

(57) ABSTRACT

Devices, systems and methods for solar powered water heater are provided. A solar powered water heater may comprise a pump, a heater structure and a solar panel. The heater structure in may be in communication with the pump. The solar panel may be in communication with the pump, wherein the pump is powered by the solar panel. In exemplary embodiments, the solar powered water heater floats in a pool or spa and uses solar power to drive a pump which pumps water though a heater structure before returning it to the pool or spa.

### CROSS-REFERENCE TO RELATED APPLICATIONS

This application claims benefit of and priority to U.S. Provisional Application Ser. No. 63/438,318, filed Jan. 11, 2023, and titled “SOLAR POWERED WATER HEATER” (hereinafter the '318 Application). The '318 Application is hereby incorporated by reference in their entirety for all purposes.

### FIELD

This specification relates to a system, device, apparatus and/or a method for heating a swimming pool.

### BACKGROUND

In bodies of water, such as swimming pools or spas, it may be desired for the water to be heated. Various water heater devices exist for heating water. Existing water heaters for pools may require systems built into the foundation of the pool. Further existing water heaters may require external power to be provided to the water heater. Black tarps or other heat conductive material may be placed on a body of water to raise the waters temperature, however these current methods are energy inefficient, cumbersome, and may not achieve their desired effect of heating the water in an efficient manner. It would be advantageous to have a solar powered water heater that was easy to use and energy efficient.

Accordingly, there is a need for a system, apparatus and/or method for a heating a body of water, where the water heater is powered by solar power.

### SUMMARY

In an example embodiment, a solar powered water heater is disclosed. The device may comprise a pump. The pump may be configured to receive water from a body of water. The device may also comprise a heater structure having a first end in communication with the pump. The heater structure may be configured to receive the water and heat the water. The device may also comprise a solar panel in communication with the pump, wherein the pump is powered by the solar panel.

In another example embodiment, the a system for solar powered water heating is disclosed. The system may include a solar heater body comprising a top side. The system may include a pump connected the solar heater body, configured to receive water from a body of water. The system may also include a solar panel disposed on the top side of the solar heater body and configured to power the pump. Further, the system may include a heater structure having a first end and a second end, the first end of the heater structure connected to the pump and configured to receive water from the pump and carry water from the first end to the second end of the second end of the heater structure. The system may include an outlet spout connected to the second end of the heater structure, the outlet spout configured to return heated water to the body of water.

In another example, a method for heating water is disclosed. The method may comprise absorbing solar energy by a solar panel. The method may further include converting solar energy to electric power. The method may further include powering a pump using the electric power. The method may further include pumping water, by the pump, from a body of water into a heater structure. The method may further include warming the water by solar heat as the water flows through the heater structure. The method may further include returning the heated water to the body of water.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale, and may be exaggerated to better illustrate the important features of the present disclosure.

FIGS. 1A and 1B are block diagrams of a solar powered water heater, according to various embodiments of the disclosure.

FIG. 2 is a block diagram of a solar powered water heater with a heating device, according to various embodiments of the disclosure.

FIGS. 3A and 3B illustrate a solar powered water heater, according to various embodiments of the disclosure.

FIGS. 4A and 4B illustrate a solar powered water heater, according to various embodiments of the disclosure.

FIG. 5 illustrates a solar powered water heater with a support structure, according to various embodiments of the disclosure.

FIGS. 6A and 6B illustrate a solar powered water heater with a heater structure, according to various embodiments of the disclosure.

FIG. 7 shows a method for heating water using a solar powered water heater according to various embodiments of the present disclosure.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Furthermore, any reference to singular includes plural embodiments, and any reference to more than one component may include a singular embodiment.

In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, a solar powered water heater may be used to warm water in a body of water, such as a pool or pond or hot tub. The solar powered water heater may couple an active heat exchanger with a passive radiant heater to heat a body of water. The solar powered heat exchanger may float in a body of water or be free-standing next to a body of water.

The solar powered water heater may include a pump for receiving water from the body of water. The solar powered water heater may use the pump to remove water from a body of water. When the water is received the temperature may be cooler than the air above the water. The pump may be powered by a solar panel. The pump may be powered by energy derived from a photovoltaic (PV) solar panel or other types of solar power. The solar powered water heater is configured to heat the water before returning it to the body of water. The solar powered water heater may heat the water in the solar heater body panel, which is separate from the pools main pump and filtration system. The solar panel may be able to absorb solar energy from light or the sun. In various embodiments, the solar panel may convert the solar energy to electricity. In various embodiments, an energy storage device may receive the electricity from the solar panel and store the electricity. In various embodiments, a heater structure may be attached to the pump. The pump may push the water through the heater structure using the electricity. The heater structure may be a heat exchange to heat the water in the tube or other heating structure. The heater structure may be colored black or other dark colors to increase the heat exchange. For example, in various embodiments, the heater structure is black colored to maximize solar heat absorption. In various embodiments, the heater structure may cover a large surface area to allow for greater heat absorption and greater water heating. An outlet spout may return the heated water to the body of water.

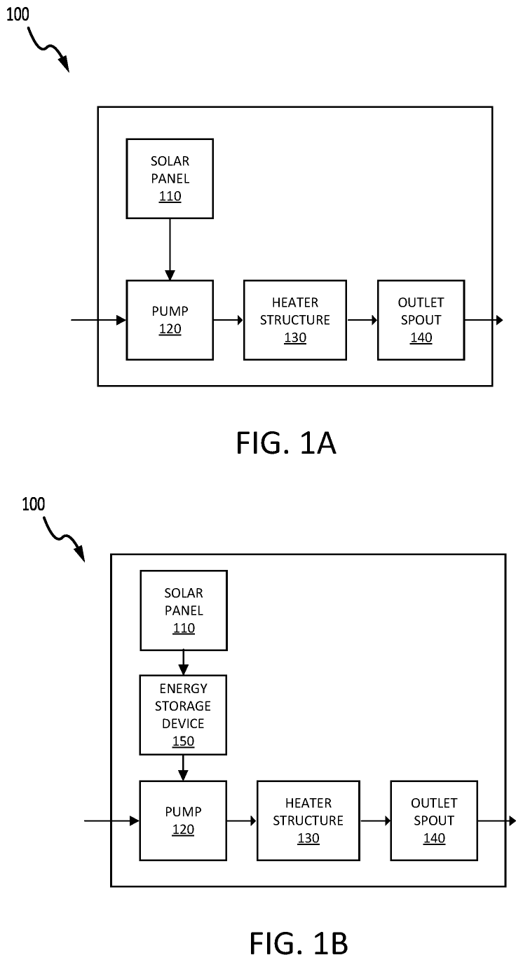

Referring to FIGS. 1A and 1i, a block diagram of a solar powered water heater is illustrated according to various embodiments of the disclosure. The solar powered water heater 100 may comprise a solar panel 110, a pump 120, a heater structure 130, and an outlet spout 140. In various embodiments, the solar powered water heater 100 may further comprise an energy storage device 150.

In various embodiments, the solar panel 110 may absorb solar energy. The solar panel 110 may be a photovoltaic (PV) solar panel, comprising photovoltaic cells. The solar panel 110 receives light and convert the light to electricity. The solar panel 110 may be any device capable of generating electricity by solar power. In various embodiments, the solar panel 110 may absorb solar energy in order to collect and store energy. The solar panel 110 may comprise an energy converter to convert the electricity. The solar panel 110 may be in communication with the pump 120. In various embodiments, the solar panel 110 may power the pump 120. In various embodiments, the solar panel 110 may further comprise a parabolic shroff configured to direct sunlight for greater sunlight absorption.

In various embodiments, a pump 120 may be used to receive water from the body of water. In various embodiments, the pump 120 may be in communication with the solar panel 110. The pump 120 may be powered by the energy from the solar panel 110. In various embodiments, the pump 120 may be a self-priming pump. The pump 120 may pull or draw water from the body of water. The pump 120 may be in communication with the heater structure 130. For example, the pump 120 may push water into the heater structure 130.

In various embodiments, the heater structure 130 may receive water from the pump 120. The heater structure 130 may heat the water. In various embodiments, the heater structure 130 may heat the water using the heat exchanger. In various examples, the heater structure 130 may be tube. For example, the heater structure 130 may be bade of a metal or plastic tubing. In various embodiments, the hot air or sunlight may provide heat to the heater structure 130. In various embodiments, the heater structure 130 may be energy derived from a photovoltaic (PV) solar panel. The heater structure 130 may then output the water to the outlet spout 140.

In various embodiments, the outlet spout 140 may be in communication with the heater structure 130. The outlet spout 140 may receive water from the heater structure 130 and output the water into the body of water.

In various embodiments, with reference to FIG. 1B, the solar powered water heater 100 may further comprise an energy storage device 150. In various embodiments, the energy storage device 150 may be in communication with the solar panel 110. The energy storage device 150 may receive power from the solar panel 110. The energy storage device 150 may power the pump 120. In various embodiments, the energy storage device 150 may comprise a battery to store electricity. The energy storage device 150 may be connected to the pump 120. The energy storage device 150 may provide electricity to the pump 120. In various embodiments, the energy storage device 150 may store the electric power and to provide power to the pump 120.

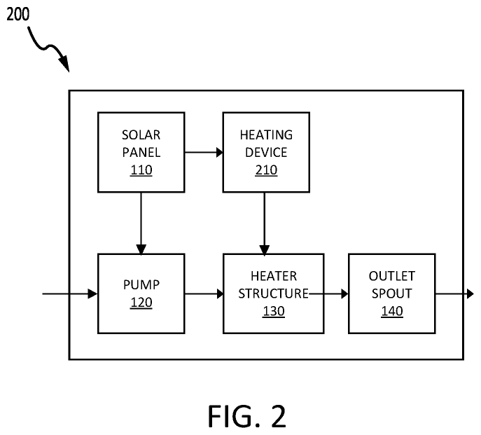

With reference to FIG. 2, in various embodiments, the solar powered water heater 200 may comprise a solar panel 110, a pump 120, a heater structure 130, an outlet spout 140, and a heating device 210. In various embodiments, the heating device 210 may receive electricity from the solar panel 110. The heating device 210 may provide heat to the heater structure 130. For example the heating device 210 may comprise coils or heat conductive material to heat the water as it sits in or flows through the heater structure 130.

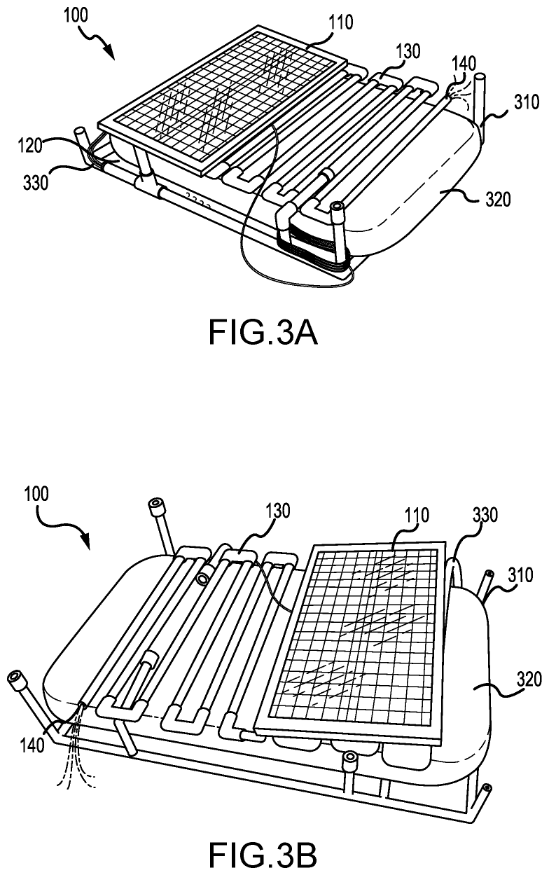

With reference to FIGS. 3A and 3B, in various embodiments, the solar powered water heater 100 may comprise a solar heater body 310. The solar heater body 310 may be attached to the solar panel 110, the pump 120, the heater structure 130, and the outlet spout 140 so that the solar powered water heater 100 may move freely in a body of water and not be connected to any external devices. The solar heater body 310 may comprise a flotation device 320. For example, the solar heater body 310 may be made of a foam or inflatable material that makes itself buoyant in a body of water. The solar heater body 310 may allow the solar panel 110 and heater structure 130 to float above the surface of the body of water.

In various embodiments, the solar heater body 310 may comprise a top side and a bottom side. The bottom side of the solar heater body 310 may be in communication with the body of water wherein the solar powered water heater 100 may float in the water. The top side of the solar heater body 310 may be in contact with the solar panel 110 and the heater structure 130. For example the top side of the solar heater body 310 may be a platform that supports the solar panel 110 and the heater structure 130 as it floats in a body of water.

In various embodiments, the solar powered water heater 100 may float on a body of water. The solar powered water heater 100 may include a flotation device 320 that may be used to float the solar panel 110, pump 120, heater structure 130, and heating device 160 above water. The flotation device 320 may be a hollow structure or an inflatable device which can float in a body of water. In various embodiments, the flotation device 320 may be made of a foam or other material which floats in water. In various embodiments, the flotation device 320 may be an inflatable device which can be pumped with air to float on the surface of water. In various embodiments, the flotation device 320 may provide a platform for the solar panel 110, heater structure 130, as well as any additional devices which may assist the solar powered water heater 100. The flotation device 320 may allow the solar panel 110 and the heater structure 130 to float on top of the water.

In various embodiments, the solar powered water heater 100 may include a pump 120. The pump 120 may be connected to a pump spout 330. in various embodiments, the pump spout 330 may extent into the body of water to receive water from the body of water. The pump spout 330 may extend deeper into the body of water to pull colder water from the body of water than the surface water. For example, the pump spout 330 may extend 0.5 meters into the body of water to receive water from the body of water. The pump 120 may pull the water into the pump spout 330 and output the water into the heater structure 130.

In various embodiments, the heater structure 130 may comprise a plurality of tubes as shown in FIGS. 3A and 3B. The plurality of tubes of the heater structure 130 may be parallel tubes. For example, the plurality of parallel tubes of the heater structure 130 may be connected to cover a portion of the solar panel body. The plurality of parallel tubes of the heater structure 130 may be arranged to provide a greater surface area. The plurality of tubes of the heater structure 130 may be connected to cover a portion of the top side of the solar heater body 310. The heater structure 130 may have a snake or spiral to create a greater surface area to provide greater heat to the water as it flows through the heater structure 130. The heater structure 130 may be colored black or a dark color to increase solar absorption. For example, dark colors or black provide greater heat exchange. In various embodiments, the heater structure 130 may have a first end and a second end. The pump 120 may be connected to the first end of the heater structure 130. The first end of the heater structure 130 may be configured to receive water from the pump 120. The water may flow from the first end to the second end of the heater structure 130. The pump 120 may assist the water to flow from the first end to the second end of the heater structure 130. The outlet spout 140 may be connected to the second end of the heater structure 130 and configured to return the heated water to the body of water.

In various embodiments, the solar powered water heater 100 may comprise an outlet spout 140 in communication with the second end of the heater structure 130. The outlet spout 140 may output the heated water to the body of water after it has been heated by the solar powered water heater 100. In various embodiments, the heater structure 130 may comprise a tube, wherein the tube is configured to provider greater surface area to warm the water.

In various embodiments, the solar powered water heater 100 may further comprise a switch or electrical switch for activating and stopping the powering of the pump 120. For example, the solar powered water heater 100 may comprise a switch for controlling the power to the pump 120.

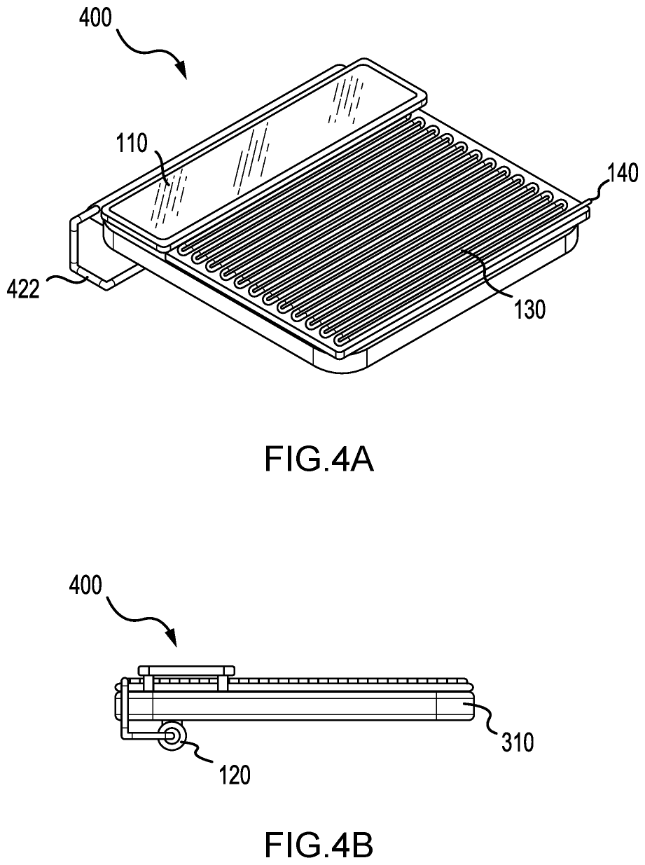

With reference to FIGS. 4A and 4B, in various embodiments, the solar powered water heater 400 may comprise a solar panel 110, a pump 120, and a heater structure 130 and an outlet spout 140 each connected to the solar heater body 310. In various embodiments, the pump 120 may be connected to an inlet tube 422. The inlet tube 422 may connect to the heater structure 130 and the pump 120 In various embodiments, the pump 120 may be below the water line of the body of water. For example, the pump 120 may extend below the solar heater body 310. The pump 120, in various embodiments, may be above the water line.

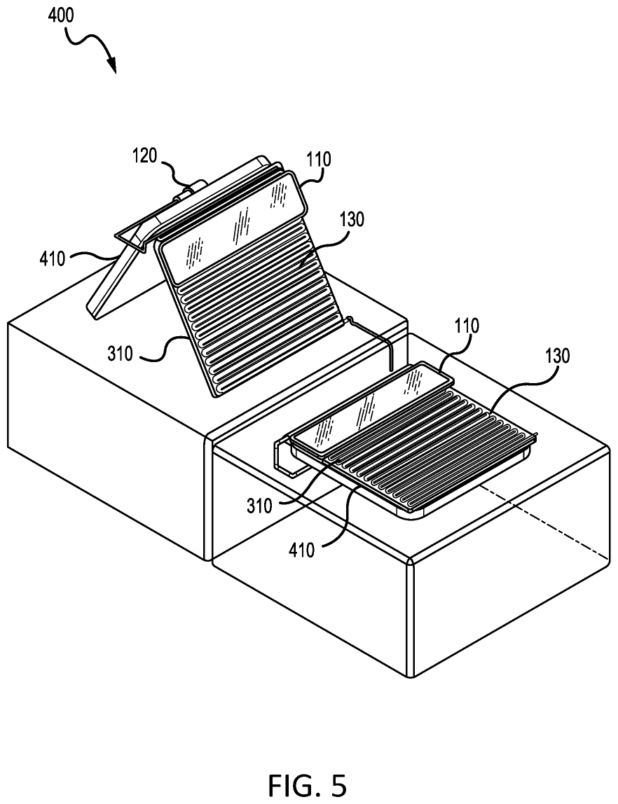

With reference to FIG. 5, in various embodiments, the solar powered water heater 400 may include a support structure 410. The support structure 410 may be connected to the solar heater body 310. The support structure 410 may be connected to the solar heater body 310 by a hinge. The support structure 410 may be configured to change the angle of the solar panel 110 to allow for greater light absorption. In various embodiments, the solar powered water heater 400 may include a solar panel 110, a pump 120, a heater structure 130, in accordance with various embodiments. Further, in various embodiments, the solar powered water heater 400 may be propped up outside a body or water. For example, the support structure 410 may allow solar powered pool heater 400 to be propped up on land or a table. In various embodiments, the support structure 410 may be buoyant to allow the solar powered pool heater to float in a body of water. In various embodiments, the pump 120 may be positioned on the side of the support structure 410 to allow the pump 120 to be rotated in relation to the solar heater body 310. Further, the pump 120 may be placed in the water where the support structure 410 is rotated against the solar heater body 310.

In various embodiments, with reference to FIGS. 4A, 4B and 5, the pump 420 may be configured to connect to a hose. For example, the pump 120 may be configured to attach to a hose.

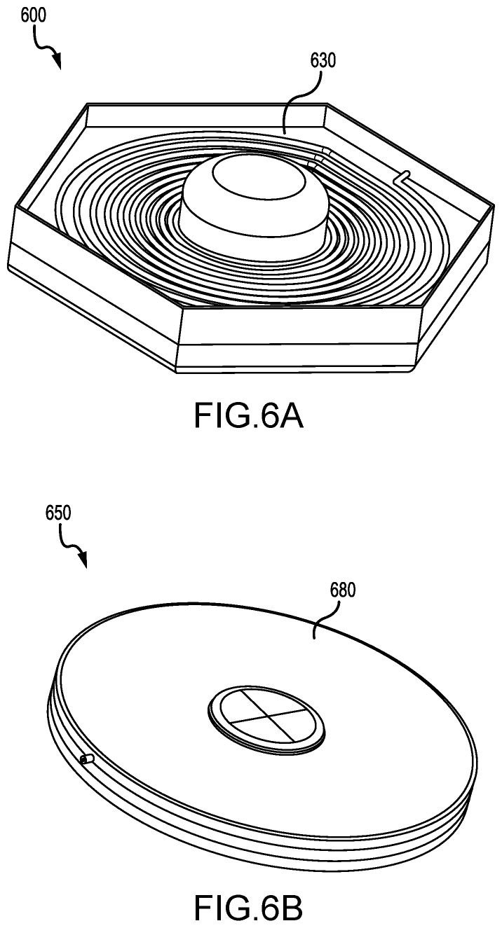

With reference to FIG. 6A, in various embodiments the solar powered pool heater 600 may comprise a heater structure 630 which is spiral in shape. For example, the heater structure 630 may be a tube that spirals on the surface of the solar powered pool heater 600.

With reference to FIG. 6B, in various embodiments, the solar powered pool heater 650 may comprise a heater structure 680 which is a reservoir or tank of water. For example, the pump 120 may pump water into the heater structure 680, wherein the heater structure 680 is able to heat the water similarly to that of the heater structure 103 and heater structure 630.

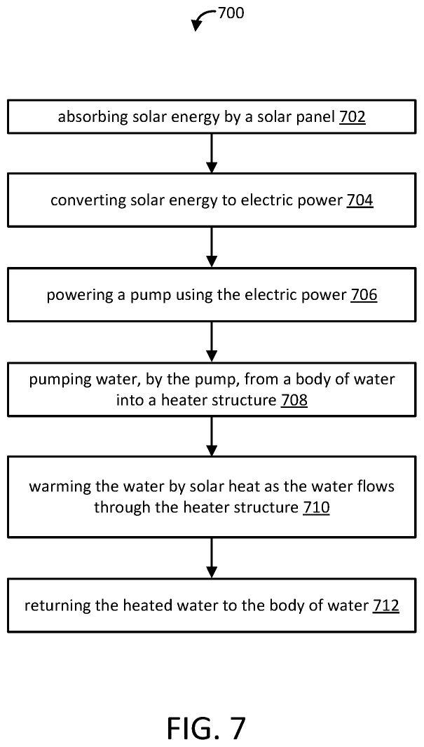

With reference to FIG. 7, a method 700 is provided. The method 700 may be for heating water. The method 700 may include absorbing solar energy by a solar panel (block 702). The method 700 may include converting solar energy to electric power (block 704). The method 700 may include powering a pump using the electric power (block 706). The method 700 may include pumping water, by the pump, from a body of water into a heater structure (block 708). The method 700 may include warming the water by solar heat as the water flows through the heater structure (block 710). The method 700 may include returning the heated water to the body of water (block 712).

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed:

1. A solar powered water heater comprising:
a pump;
a heater structure in communication with the pump; and
a solar panel in communication with the pump, wherein the pump is powered by the solar panel.

2. The solar powered water heater of claim 1, wherein the pump is a self-priming pump.

3. The solar powered water heater of claim 1 further comprising an energy storage device configured to receive power from the solar panel.

4. The solar powered water heater of claim 3, wherein the energy storage device in communication with the pump provides power the pump.

5. The solar powered water heater of claim 1, further comprising a flotation device, wherein the solar panel and the heater structure are connected to the flotation device and configured to float on top of a body of water.

6. The solar powered water heater of claim 1, further comprising an outlet spout in operable communication with the heater structure and configured to return heated water to a body of water.

7. The solar powered water heater of claim 4, wherein the heater structure is a tube, wherein the tube covers a portion of a top side of a solar panel body.

8. The solar powered water heater of claim 1, wherein the heater structure is dark colored.

9. The solar powered water heater of claim 1, further comprising an electrical switch is operatively connected to the pump.

10. The solar powered water heater of claim 1, wherein the heater structure is a solar heater.

11. A system for solar powered water heating comprising:
a solar heater body comprising a top side;
a pump connected the solar heater body, configured to receive water from a body of water;
a solar panel disposed on the top side of the solar heater body and configured to power the pump;
a heater structure having a first end and a second end, the first end of the heater structure connected to the pump and configured to receive water from the pump and carry water from the first end to the second end of the second end of the heater structure; and
an outlet spout connected to the second end of the heater structure, the outlet spout configured to return heated water to the body of water.

12. The system for solar powered water heating of claim 11, wherein the pump is a self-priming pump.

13. The system for solar powered water heating of claim 11, further comprising a support structure connected to the solar heater body, wherein the support structure changes an angle of the solar panel.

14. The system for solar powered water heating of claim 11, further comprising an energy storage device wherein the energy storage device in communication with the pump provides power the pump.

15. The system for solar powered water heating of claim 11, further comprising a flotation device, wherein the solar panel and the heater structure float on top of the solar heater body which is supported by the flotation device.

16. The system for solar powered water heating of claim 11, wherein the outlet spout is in communication with the second end of the heater structure and configured to return heated water to the body of water.

17. The system for solar powered water heating of claim 15, wherein the heater structure is a tube, wherein the tube covers a portion of a top side of a solar heater body.

18. The system for solar powered water heating of claim 11, wherein the heater structure is dark colored.

19. The system for solar powered water heating of claim 11, further comprising an electrical switch operatively connected to the pump.

20. A method for heating water comprising the steps of:
absorbing solar energy by a solar panel;
converting solar energy to electric power;
powering a pump using the electric power;
pumping water, by the pump, from a body of water into a heater structure;
warming the water by solar heat as the water flows through the heater structure; and
returning heated water to the body of water.

21. The method of claim 20, wherein the pump is a self-priming pump.
